(19) United States
(12) Patent Application Publication
(10) Pub. No.: US 2012/0037251 A1
(43) Pub. Date: Feb. 16, 2012

(54) Fluidic System

(75) Inventor: Michael Ohmer, Wendlingen (DE)

(73) Assignee: FESTO AG & CO. KG, Esslingen (DE)

(21) Appl. No.: 13/263,237

(22) PCT Filed: Mar. 6, 2010
(86) PCT No.: PCT/EP2010/001434

§ 371 Date: Oct. 6, 2011

(30) Foreign Application Priority Data
Apr. 17, 2009 (DE) 10 2009 017 879.1

(51) Int. Cl. F16K 11/20

(52) U.S. Cl. 137/637

(57) ABSTRACT

The invention relates to a fluidic system having a valve device for the fluid supply of fluidic loads, which has a plurality of valve modules (2); the valve modules (2) in each case comprise a channel element (11) and four 2/2-way valves (41, 42, 45, 46), which are interconnected in a full bridge arrangement and can be switched between a shut off position and an open position; and also having a control device (127) for the individual activation of the 2/2-way valves (41, 42, 45, 46) of the valve modules (2). The invention provides for the first working channel (21) and the second working channel (22) to be connected so as to communicate via a connecting channel, and for the valve module (2) to be assigned a valve means (124) which can be switched individually by the control device (127) between a shut off position and an open position so as to influence a free cross section of the connecting channel, in order to open the communicating connection between the first and second working channel (21, 22) temporarily.

The invention relates to a fluidic system, having a valve device for supplying fluid to fluid consuming devices, which has a plurality of valve modules; the valve modules in each case comprise a channel body, which has a feed channel opening designed to connect to a source of fluid, two work channels provided to couple to fluid consuming devices and a de-aeration channel opening serving to de-aerate fluid consuming devices, and four 2/2-way valves which in each case have a first and a second fluid connection and a movable valve member for adjusting a free fluid channel cross-section between the first and the second fluid connection, wherein the four 2/2-way valves of the valve modules are interconnected in a full bridge arrangement, in which the first fluid connections of the first and second 2/2-way valves are connected to the feed channel opening, the second fluid connection of the first 2/2-way valve and the first fluid connection of the fourth 2/2-way valve are connected to a first work channel, the second fluid connection of the second 2/2-way valve and the first fluid connection of the third 2/2-way valve are connected to a second work channel and the second fluid connections of the third and fourth 2/2-way valves are connected to the de-aeration channel opening, and wherein each 2/2-way valve can be switched between a shut-off position and an open position; and also having a control device for individually activating the 2/2-way valves of the valve modules.

A multi-way valve with a freely configurable valve function is known from DE 102 08 390 A1, which comprises a plurality of pressure-medium connections arranged on a valve body and a drive unit which can be electrically activated to actuate a valve mechanism housed in the valve body. The valve mechanism consists of at least four individual 2/2-way main valves connected in series with pressure-medium connections arranged in between. An electrical drive element, which is connected to a common electronic control device, is assigned to each individual main valve. Different-way valve functions can be freely selected using the multi-way valve.

A valve arrangement for gaseous and fluid media is known from DE 103 15 460 B4. This comprises at least four 2/2 way valves linked to a multi-way valve unit in full bridge arrangement, to which an electrical control unit, having at least one bus connection, at least one sensor connection and at least one pulse-width modulation, is assigned. The way valves are designed as rapid-switching plate armature valves, the switching time of which is less than 5 milliseconds.

EP 0 391 269 B1 discloses a solenoid valve battery having a plurality of solenoid valves, arranged on a common base plate, which can be collectively supplied with compressed air on the input side via a channel integrated into the base plate. The channel is connected to a branch line which exits at two opposing surfaces of the base plate.

A solenoid valve is known from EP 1 748 238 B1, which has a base body, through which valve channels pass, and a magnet head having an electromagnetic device. A valve chamber communicating with a plurality of valve channels is arranged between the magnet head and the base body which are arranged sequentially in the direction of a main axis. The valve chamber contains a plate-shaped magnet armature which acts as a valve member and can be attracted by a stationary magnet core arrangement of the electromagnetic device.

U.S. Pat. No. 6,598,391 discloses a valve arrangement consisting of a plurality of interconnected 2/2-way valves for activating a hydraulic cylinder, in which an overpressure valve is in each case assigned to the two work channels connected to the hydraulic cylinder. In this way, a rise in pressure in one of the two work chambers of the hydraulic cylinder, caused by the mass inertia of the hydraulic cylinder and the load coupled with it, is to be restricted when there is a rapid deceleration of the hydraulic cylinder when it is moving, which occurs by shutting off the assigned 2/2-way valves.

The object of the invention is to provide a fluidic system which has improved efficiency when using fluids, in particular in the case of a fluidic drive system.

For a fluidic system mentioned at the outset, this object is achieved with the features of Claim 1. Provision is made here for the first work channel and the second work channel to be connected so as to communicate via a connecting channel and for the valve module to be assigned a valve means which can be switched individually by the control device between a shut-off position and an open position to have an influence on a free cross-section of the connecting channel, in order to temporarily open the communicating connection between the first and the second work channels. With the connecting channel being temporarily opened by means of the valve means, a fluid exchange can be effected between the two work channels, without the 2/2-way valves of the full bridge circuit, which in each case open the connection to a feed channel or a de-aeration channel, having to be activated for this purpose. Therefore, the fluid can be exchanged between the two work channels without an additional fluid supply or fluid losses, by which means the range of functions for the valve modules is extended.

Advantageous further embodiments of the invention are specified in the sub-claims. Unless otherwise mentioned, the expression “a” or “one” is to be understood in the sense of “at least one”.

It is advantageous if the connecting channel is formed in a channel unit which has two fluid channels, designed to produce a communicating connection to the work channels, and which is designed to attach to a connection area of the valve module. By means of the additional module, the fluid flows provided in the work channels of the valve module, according to the setting of the valve means, can be conveyed separately from one another or mixed together. Due to the separate design of the additional module, which comprises the channel unit and the valve means, the additional module can be fitted, if required, to the respective valve module in a compact constructive form and built together with the valve module into the valve device. It is advantageous if the valve means is attached to the channel unit, since a constructively simple design for the channel unit can hereby be achieved. The valve modules, with joining areas facing one another, are arranged next to one another along a stacking direction and thereby form the valve device. The work channels of the valve modules exit at a connection area which is aligned perpendicular to the stacking direction and perpendicular to the joining area. The channel unit is designed to abut on the connection area, wherein the fluid channels of the channel unit can be overlapped with the work channels of the channel body.

It is particularly advantageous if the additional module for arrangement in sequence in an assembly direction is formed parallel to the surface normal of the connection area of the valve module or onto another additional module, so as to form an additional module arrangement. This thereby ensures that additional modules arranged on one or on a plurality of valve modules do not impede the stacking of the valve modules to form the valve device. In addition, a communicating connection is thereby simply ensured between the additional module assigned to the respective valve module and the work channels of the valve module exiting at the connection area. It is furthermore advantageous if a plurality of additional modules is attached to a valve module, arranged next to one another in the assembly direction, whereby the range of functions of the valve module can be extended by a plurality of additional functions, without impeding the stacking of the valve modules forming the valve device.

It is advantageous if the valve means is designed as a 2/2-way valve. A valve means designed in such a way can have a similar structure to the 2/2-way valves of the valve module, preferably identical to the 2/2-way valves of the valve module. Advantages can hereby be gained with respect to the production costs for the valve device, as well as for the design of the control device, since this can be exclusively designed to activate 2/2-way valves.

It is advantageous if the control device for intermittently activating the 2/2-way valves of the valve modules and the valve means is designed in the style of proportional servo valves, in particular by applying a pulse-width modulation method. The 2/2-way valves are preferably designed as on-off valves which when activated by the control device can be switched from one switch state, for example the closed position, into another switch state, for example the open position. A fluid volume flow can be controlled or regulated by the respective 2/2-way valve by switching rapidly between the two switch states. By varying the frequency of the switching signals for the 2/2-way valve and/or the switching-on duration of the 2/2-way valves, switching behaviour can be obtained for the fluid flow which at least almost corresponds to the switching behaviour of a proportional valve or proportional servo valve. The 2/2-way valves of the valve module and/or of the valve means are, for example, activated by pulse-width modulation. Here, the relationship between the switching-on duration and the switching-off duration (duty cycle) is varied at a constant switching frequency, in order to adapt the fluid volume flow to the requirements by means of the 2/2-way valve or the valve means.

In one embodiment of the invention, provision is made for a detection device, in particular a pressure sensor and/or a flow sensor and/or a temperature sensor and/or a moisture sensor, to be arranged on and/or in the connecting channel, to determine an electrical measurement signal as a function of the fluid flowing in the connecting channel, the detection device being electrically coupled to the control device. Depending on the type of detection device, a sensor is in direct contact with the fluid flow, for example a moisture sensor or a temperature sensor, or the sensor is arranged on a wall of the connecting channel away from the flowing fluid, for example a flow sensor. Using the detection device, one or more parameters can be determined for the flowing fluid and transmitted as electrical signals to the control device.

Preferably, the control device is set up to activate the 2/2-way valves and the valve means in such a way that a temporary opening of the communicating connection between the first and the second work channels can be specified as a function of an operating state of a fluidic component coupled to the fluid channel and/or as a function of an electrical measurement signal of a detection device. An at least essentially loss-free exchange of fluid between the two work channels is hereby possible, which allows the energy stored in the fluid to be utilised more efficiently.

In a further embodiment of the invention, provision is made for a first drive chamber of a fluidic drive device, in particular a fluid cylinder, to be connected in communicating fashion to the first work channel and a second drive chamber of the fluidic drive device to be connected in communicating fashion to the second work channel, and for the drive chambers to be separated from one another by a linearly movable drive element. For example, the fluidic drive device can be a pneumatic cylinder, in which a linearly movable piston acting as a working element divides a cylinder area into a first and a second drive chamber which can be varied in size. By means of the combination according to the invention of the full bridge circuit with the connecting channel, which connects the work channels and can be opened by the valve means, the fluidic drive device can not only be operated like a motor, which converts fluidic energy into kinetic energy, but also like a fluidic generator, in which kinetic energy is converted into fluidic energy. As a result of this, depending on the field of application of the fluidic drive devices, significant savings can be achieved with regard to fluid consumption.

It is advantageous if the control device is set up to activate the 2/2-way valves and the valve means in such a way that aerating or de-aerating the first drive chamber can be specified independently of de-aerating or aerating the second drive chamber. The aim of utilising the fluid more efficiently can be achieved, for example, by releasing pressure from, in particular de-aerating, the pressurised drive chamber before the other drive chamber is pressurised. The fluidic drive device can in this case be moved with lower fluid pressure and/or higher motion speed of the drive device, since less fluid volume has to be displaced from the drive chamber which is pressurised up to that point.

Preferably, the control device is set up to activate the 2/2-way valves and the valve means in such a way that when a drive element, which is accommodated free to move in the drive chambers, approaches an end position, determined by minimal volume in the respective drive chamber, an at least partial pressure equalisation between the drive chambers can be specified, so that the kinetic energy of the drive element can at least partially be converted into fluid pressure of a working fluid. A gentle deceleration of the fluidic drive device can hereby be brought about with little effort before a mechanically induced end position is reached. Before reaching the end position, for example both the pressure supply to the one drive chamber and the release of pressure from the other chamber, which in each case occurs via the valve module, are switched off or shut off. In order to prevent a deceleration which is too rapid or even a reverse movement of the fluidic drive device, which without further measures would ensue due to the compression of the fluid in the drive chamber which gets smaller due to the movement of the drive element, firstly, due to the pressure release being shut off, an increase in pressure occurs in the drive chamber which gets smaller owing to the movement of the drive element. At the same time, a fall in pressure occurs in the other drive chamber which enlarges due to the movement of the drive element. The speed of the drive element is reduced owing to the sinking pressure difference between the two work chambers and the build-up of pressure in the one work chamber. By means of a targeted pressure equalisation between the two drive chambers by temporarily opening the connecting channel, the pressure difference between the two drive chambers is additionally reduced and at least one part of the kinetic energy of the drive element is converted into increased fluid pressure in the fluid acting as the working fluid. In addition, the desired reduction in the motion speed of the fluidic drive device occurs. By means of these measures, on the one hand, the fluid pressure in the drive chambers can be a kept at a specifiable level, which with a further movement of the drive element leads to savings with respect to fluid consumption. On the other hand, design measures in the fluidic drive device to ensure the end position is damped can, as a result, be made simpler or end position damping can be dispensed with completely.

In one advantageous embodiment of the invention, provision is made for the control device to be set up to activate the 2/2-way valves and the valve means in such a way that a pressure difference between the first and the second drive chambers of the fluidic work device can be specified to be constant in the course of a movement of the drive element. By this means, the situation is prevented where a movement of the fluidic drive device occurs which is too rapid due to large pressure differences, which then has to be slowed down again. In addition, the fluidic drive device when using a compressible fluid, in particular compressed air, obtains a higher rigidity, due to the increased pressure level in both drive chambers, and hence is less strongly deflected from a specifiable position by external force effects.

Preferably, the control device is set up to activate the 2/2-way valves and the valve means in such a way that in the course of a movement of the drive element, particularly by intermittently activating the valve means, a pressure equalisation can be specified between the drive chamber of the fluidic work device made smaller by the movement of the drive element and the drive chamber of the fluidic work device enlarged by the movement of the drive element. The fluidic drive device can hereby, for example, be used as a generator, in which the kinetic energy of the drive element is used for pressurising, in particular compressing, fluid. For example, a hydraulic accumulator can be filled or pressure can be equalised between the drive chambers of the fluidic drive device with the pressurised in particular compressed fluid.

In a further embodiment of the invention, provision is made for the 2/2-way valves to be designed as valve units, in which the actuation means forms a compact unit with a valve section, this compact unit being attached to the mounting area of the channel body or channel unit, wherein the valve section comprises the first and the second fluid connections and a valve seat, with respect to which the valve member is arranged free to move, in order to have an influence on the free fluid channel cross-section between the first and the second fluid connections between a shut-off position and an open position. With this embodiment of the invention, the 2/2-way valves are formed completely outside the channel body and are attached as compact units to the mounting area of the channel body. As a result, on the one hand, the construction of the channel body is made simpler, since no arrangements need to be made for designing a valve seat or for accommodating and supporting valve elements. On the other hand, the 2/2-way valves can hereby be advantageously replaced in case of damage, since the valve units can be removed and replaced as a complete structural component.

In addition to the actuation means which can be electrically activated, the 2/2-way valves comprise the valve section which serves to convey fluid. The valve section has a fluid channel which exits on an outer surface into two fluid connections spaced apart from one another. A valve seat is formed in the fluid channel which enables the valve member to form a sealing abutment to shut off the free cross-section of the fluid channel. The valve member can be influenced by a force effect, originating from the actuation means, in such a way that it assumes either the shut-off position or the open position. The outer surface of the valve section, at which the fluid connections exit, is designed to form a flat, sealing abutment on the mounting area of the channel body. The fluid connections are designed as communicating connections to fluid channels in the channel body.

The four valve units of the valve module are all designed in an identical way and are in each case attached to the channel body with discrete fixing means, for example designed as screws. Individual valve units can be replaced easily in case of damage due to the identical design of the valve units and their being individually attached to the channel body.

An advantageous exemplary embodiment of the invention is illustrated in the drawing, in which:

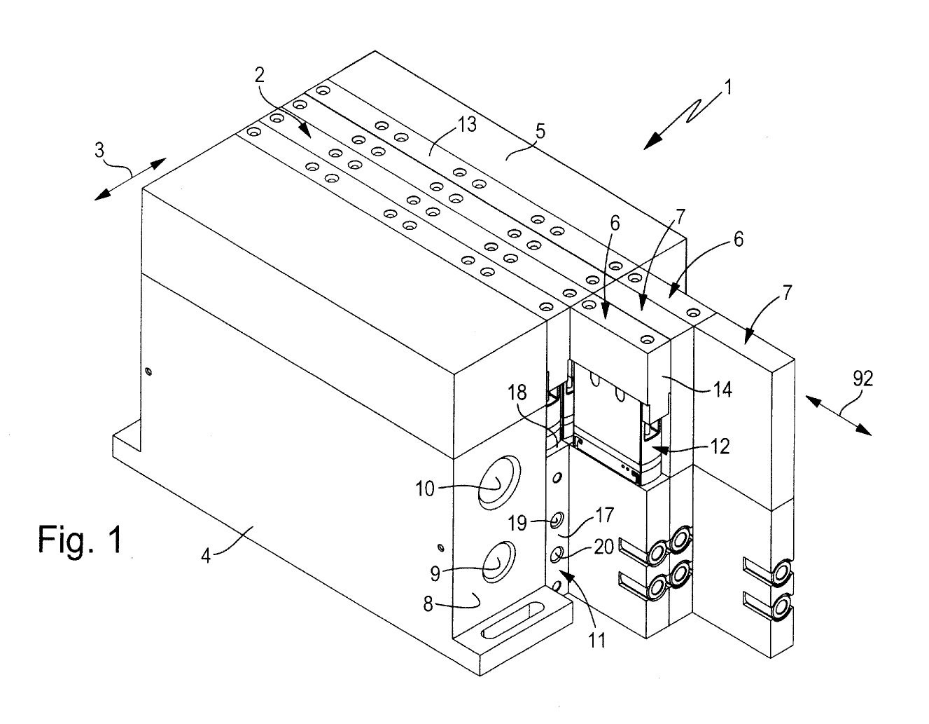

FIG. 1 shows a perspective illustration of a fluidic system having a valve device,

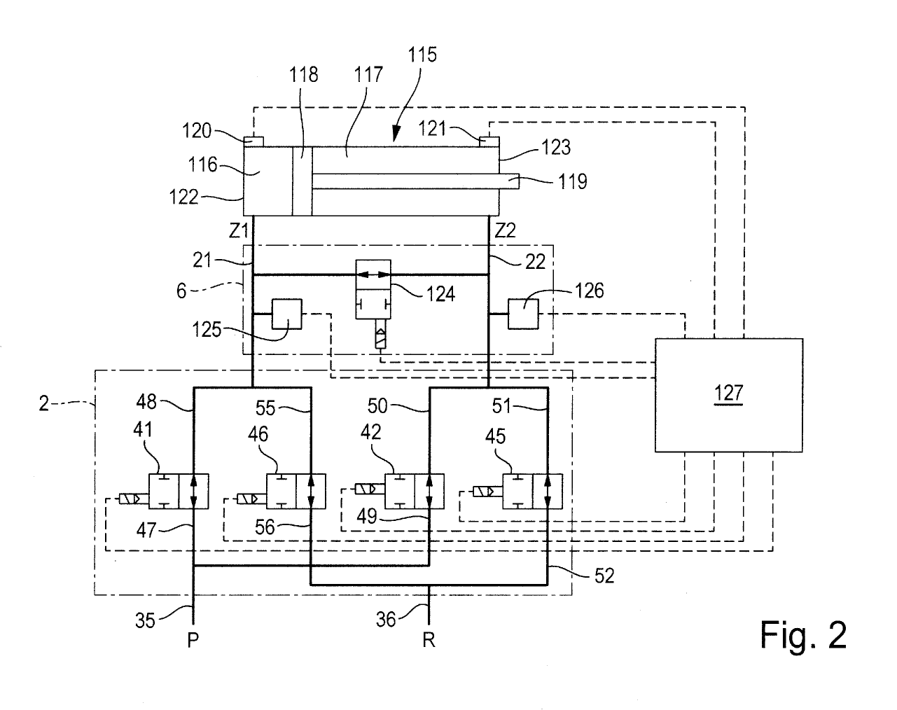

FIG. 2 shows a pneumatic equivalent circuit diagram for the fluidic system according to FIG. 1 and

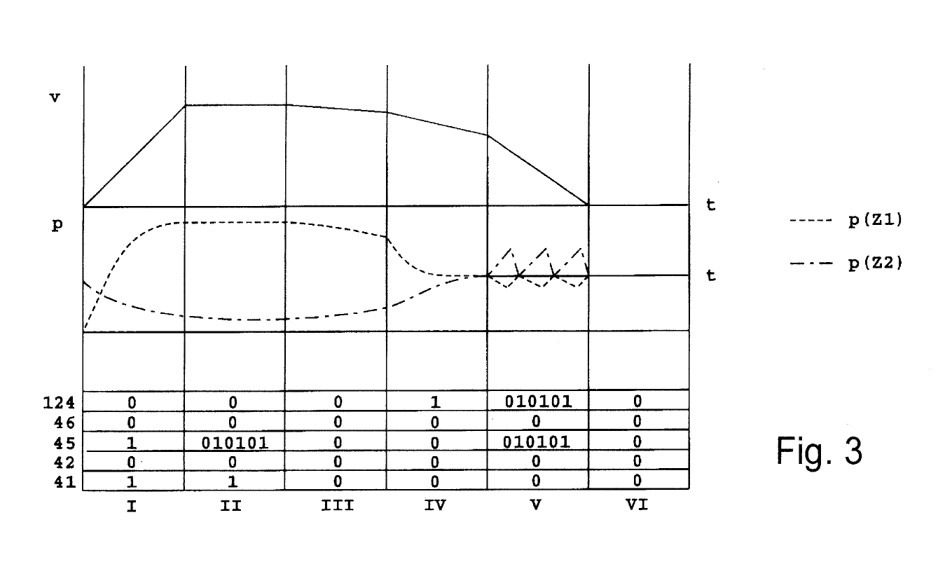

FIG. 3 shows a schematic diagram with switch positions of 2/2-way valves and pressure courses in the two work channels.

A fluidic system illustrated in FIG. 1 comprises a valve device 1 and a control device which is provided to activate the valve device 1 and is not illustrated. The valve device 1 is designed for supplying fluid to a plurality of fluid consuming devices which are not illustrated, for example pneumatic work cylinders. It serves to control and/or regulate a plurality of fluid flows which are to be provided from a fluid source, which is not illustrated, to the respective fluid consuming devices by means of control signals from the control device which is not illustrated.

The valve device 1 comprises a plurality of valve modules 2, which are designed by way of example like slices and are lined up next to one another in a stacking direction 3. The valve modules 2 are arranged between a base element 4 and an end plate 5, which in each case delimit the valve device 1 at either end along the stacking direction 3.

Additional modules 6, 7 are assigned to some of the valve modules 2, which, for example, are designed as valve elements or sensor elements. The additional modules 6, 7 can, as becomes apparent from FIG. 1, be added to one another in an assembly direction 92 which is orthogonal to the stacking direction 3 and enable the range of functions of the valve modules 2 to be extended if required.

The base element 4 is in the present case cuboid in shape and has on an end face 8, the surface normal of which is aligned orthogonally to the stacking direction 3, a feed opening 9 for connecting a fluid conveyer, which is not illustrated, via which pressurised fluid or fluid under negative pressure can be provided. The base element 4 in addition has a de-aeration opening 10 which, for example, can act as an outlet for fluid which has already flowed through the valve device 1 and the fluid consuming devices which are not illustrated. When using the valve device 1 for controlling and/or regulating gas flows, in particular compressed air flows, a sound attenuator, which is not illustrated, can be arranged at the de-aeration opening 10 of the base element 4.

With the illustrated exemplary embodiment of the valve device 1, a plurality of valve modules 2 is lined up to the base element 4 in the stacking direction 3, which all have the same design. The valve modules 2 have the function of delivering the fluid provided via the base element 4 to the fluid consuming devices, which are not illustrated, in the desired manner and, as appropriate, of conveying fluid flowing back from fluid consuming devices back again to the base element 4.

Each of the valve modules 2 comprises a plate-shaped channel body 11 and uniformly designed valve units 12 attached to the channel body 11. The valve units 12 of the valve module 2 are provided with a covering strip 13 which can, for example, be designed as sound insulation for the valve units 12 and/or to shield them against environmental impacts, in particular contaminants, and/or to electrically contact the valve units 12. The valve unit 12 of the additional module 6 is provided with a covering hood 14 which fulfils the same function for the individual valve unit 12 as the covering strip 13 for the plurality of valve units 12 of the valve module 2.

The plate-shaped channel body 11, which, for example, can have a cubic outer geometry, has two opposing joining areas, whose surface normals, which are not illustrated, are aligned parallel to the stacking direction 3. Of the narrow sides of the channel body 11, which are aligned orthogonally to the joining areas and whose surface normals, which are not illustrated, run perpendicular to the stacking direction 3, a shorter narrow side acts as the connection area 17 and a longer narrow side acts as the mounting area 18.

With the valve module 2, connection openings 19, 20 of a first and second work channel 21, 22 exit at the connection area 17. The first work channel 21 provides a communicating connection between a fluid consuming device, which can be connected to the connection opening 20, and the first 2/2-way valve 41, as well as the fourth 2/2-way valve 46. The second work channel 22 provides a communicating connection between the connection opening 19 and the second 2/2-way valve 42, as well as the third 2/2-way valve 45.

As can be seen from the schematic illustration in FIG. 2, the first work channel 21 denoted by Z1 is connected in communicating fashion to the second fluid connection 48 of the first 2/2-way valve 41 and to the first fluid connection 55 of the fourth 2/2-way valve 46. The second work channel 22 denoted by Z2 is connected in communicating fashion to the second fluid connection 50 of the second 2/2-way valve 42 and to the first fluid connection 51 of the third 2/2-way valve 45. In addition, the first fluid connection 47 of the first 2/2-way valve 41 and the first valve connection 49 of the second 2/2-way valve 42 are connected in communicating fashion to the feed channel opening 35 which is denoted by P. The second fluid connection 52 of the third 2/2-way valve 45 and the second valve connection 56 of the fourth 2/2-way valve 46 are connected in communicating fashion to the de-aeration channel opening 36 which is denoted by R. This interconnection of the 2/2-way valves 41, 42, 45, 46 is also referred to as a full bridge interconnection and enables individually communicating connections between the feed channel section 35 and the work channels 21, 22 and the de-aeration channel section 36 to be shut off or opened. In addition to the full bridge circuit, the work channels 21, 22 can be connected to one another by means of the additional module 6, whereby additional functions for the fluid flows can be obtained.

In the exemplary embodiment illustrated in FIG. 2, a fluidic drive device 115, designed by way of example as a pneumatic work cylinder, is provided, the first drive chamber 116 of which is connected to the first work channel 21. The second drive chamber 117 of the fluidic drive device 115 is connected to the second work channel 22. A detection device 125, 126, integrated in the additional module 6, is respectively assigned to the first work channel 21 and the second work channel 22 and can be designed as a pressure sensor, flow sensor, temperature sensor, moisture sensor or as a combination thereof.

The two drive chambers 116, 117 are separated from one another by a linearly movable drive element 118, which is by way of example designed as a fluid piston, and are variable in size owing to the drive element 118 being displaceable. The drive element 118 is coupled to an actuation means 119 designed by way of example as a piston rod, the actuation means 119 enabling a transmission of motion from the drive element 118 to a body, which is not illustrated, for example a machine element. A position sensor 120, 121 is respectively attached on each end to an outer periphery of the drive chambers 116, 117 and can detect when the drive element 118 approaches the respective end face 122, 123 of the drive chambers 116 and 117, and subsequently provides an electrical signal.

The position sensors 120, 121 are also, like the 2/2-way valves 41, 42, 45, 46 of the valve module 2 and the additional module 6 which comprises a 2/2-way valve 124 and two detection devices 125, 126, connected to a control device 127 by means of connection lines which are illustrated as dashed lines and not referred to in more detail. The control device 127 is set up to process measurement signals which in particular can be provided by the detection devices 125, 126, with also suitably configured 2/2-way valves 41, 42, 45, 46, 124 and position sensors 120, 121. The control device 127 is additionally set up to provide electrical control signals or electrical control energy for actuating the 2/2-way valves 41, 42, 45, 46, 124. A plurality of valve modules 2 and, where appropriate, additional modules 6, 7 coupled to them can be activated by means of the control device in a way which is not illustrated in more detail. The activation can be carried out as an open-loop control, in particular as a time control, or as a closed-loop control taking one or more measurement signals into account.

The control device 127 can, for example, be set up in such a way that it can activate the valve module 2 and the additional module 6 in such a way that the drive chambers 116, 117 of the fluidic drive device 115 are pressurised with fluid in such a way that the drive element 118, and the actuation element 119 coupled to it, moves linearly in the direction of the longitudinal axis of the actuation element 119.

The 2/2-way valves 41, 42, 45, 46 and the 2/2-way valve 124 of the additional module 6 can be activated for this purpose in the way schematically illustrated in FIG. 3. Here, a “0” in the value table denotes that the associated 2/2-way valve 41, 42, 45, 46, 124 is in the shut-off position, while a “1” in the value table specifies that the associated 2/2-way valve 41, 42, 45, 46 is in the open position and opens the fluid channel between the first and the second fluid connections of the respective 2/2-way valve 41, 42, 45, 46, 124.

In step I, the first drive chamber 116 is pressurised by activating the first 2/2-way valve 41. Due to the throttle losses in the feed lines between fluid source and drive chamber 116, only a rapid increase in pressure, rather than an erratic one, occurs in the work channel 21, and hence in the first drive chamber 116. At the same time, pressure is released in the second drive chamber 117, which by way of example is still pressurised from a previous movement step, by activating the third 2/2-way valve 45 and hence opening the connection between the second drive chamber 117 and the de-aeration section 36. A differential pressure is hereby built up between the two drive chambers 116, 117, which accelerates the drive element 118 in the direction of the drive chamber 117, the volume of which is as a result reduced.

In step II, the pressure in the work channel 21 has reached the pressure level of the supply pressure, so that a stationary state results in the work channel 21 and in the associated drive chamber 116. The first drive chamber 116 is, in addition, supplied with pressurised fluid via the first 2/2-way valve 41, while the second drive chamber 117 is at least temporarily connected in communicating fashion to the de-aeration channel section 36 by intermittently activating the third 2/2-way valve 45. By adjusting the differential pressure between the two drive chambers 116, 117, the speed of the drive element 118 can be influenced.

In step III, the supply of pressurised fluid to the drive chamber 116 is interrupted by corresponding activation of the 2/2-way valve 41 and the third 2/2-way valve 45 is brought into the shut-off position. Due to the mass inertia of the drive element 118, the actuation element 119 and, where appropriate, a machine component actuated by the actuation element 119, the drive element 118 retains its movement, wherein the speed decreases due to friction effects. Owing to the increasing enlargement of the first drive chamber 116, due to the movement of the drive element 118, the fluid pressure in the first drive chamber 116 is reduced. Pressure builds up in the second drive chamber 117 due to the activation of the third 2/2-way valve 45 into the shut-off position. As a result, the differential pressure is reduced between the drive chambers 116 and 117 and the motion speed of the drive element 118 is slowed down.

In step IV, the communicating connection between the second drive chamber 117 and the de-aeration channel section 36 is also interrupted by corresponding activation of the third 2/2-way valve 45. At the same time, the 2/2-way valve 124 of the additional module 6 is activated by the control device 127, whereby the connecting channel between the first and second work channels 21, 22 is opened and pressure is equalised between the first and the second drive chambers 116, 117. At the start of pressure equalisation, the pressure increases rapidly in the second drive chamber 117 due to the high pressure difference with respect to the first drive chamber 116. The pressures in the two drive chambers 116, 117 approach a common level with increasing equalisation in pressure. During the pressure equalisation phase, the motion speed of the drive element 118 decreases due to friction effects and the decreasing pressure difference between the two drive chambers 116, 117.

In order to bring about a smooth deceleration of the drive element 118 before reaching the end face 123, in step V a braking procedure is introduced by intermittently activating the 2/2-way valve 124 of the additional module 6, while all remaining 2/2-way valves 41, 42, 45, 46 are closed. A temporary pressure increase hereby occurs in the second drive chamber 117 due to the movement of the drive element 118, which is accompanied by a reduction in the second drive chamber 117, as long as the 2/2-way valve 124 is closed. As a result, the desired braking effect occurs. The pressurised fluid is intermittently exchanged between the two drive chambers 116 and 117 by intermittently activating the 2/2-way valve 124, in order to prevent a reverse movement of the drive element 118. The serrated pressure course in step 6, which is schematically illustrated in FIG. 3, hereby results both for the fluid pressure in the first and in the second drive chambers 116, 117 and in both work channels 21, 22. Where appropriate, the third 2/2-way valve 45 can be temporarily intermittently activated in step IV, as is also illustrated in FIG. 3, in order to prevent a build up of pressure in the second drive chamber 117 which is too rapid and a reverse movement of the drive element 118 possibly resulting from it.

Since the fluid pressure due to the equalisation in pressure by means of the 2/2-way valve 124 of the additional module 6 remains in both drive chambers 116 and 117 at a certain specifiable level, the fluidic drive device 115 has a high rigidity with respect to external forces. In addition, after carrying out the braking procedure according to step VI, less fluid is required to initiate a further movement of the drive element 118 than with a full release of pressure of the first drive chamber 116, as is required with activation procedures using multi-way valves known from the prior art. This can be attributed to the fact that both drive chambers 116, 117 are still filled with pressurised fluid. Particularly when using a compressible fluid such as compressed air, it is possible to achieve a further movement of the drive element 118, for example in the opposite direction, by now only de-aerating the work chamber 116 without a further supply of fluid. By means of the pressure difference which thereby arises between the two drive chambers 116, 117, the drive element 118 can be set in motion in the direction of the drive chamber 116.

1. A fluidic system, having a valve device for supplying fluid to fluid consuming devices, which has a plurality of valve modules; and a control device, the valve modules in each case comprise a channel body, which has a feed channel opening designed to connect to a source of fluid, two work channels provided to couple to fluid consuming devices and a de-aeration channel opening serving to de-aerate fluid consuming devices, and four 2/2-way valves which in each case have a first and a second fluid connection and a movable valve member for adjusting a free fluid channel cross-section between the first and the second fluid connection, wherein the four 2/2-way valves of the valve modules are interconnected in a full bridge arrangement, in which the first fluid connections of the first and second 2/2-way valves are connected to the feed channel opening, the second fluid connection of the first 2/2-way valve and the first fluid connection of the fourth 2/2-way valve are connected to a first work channel, the second fluid connection of the second 2/2-way valve and the first fluid connection of the third 2/2-way valve are connected to a second work channel and the second fluid connections of the third and fourth 2/2-way valves are connected to the de-aeration channel opening, and wherein each 2/2-way valve can be switched between a shut-off position and an open position, the control device individually activating the 2/2-way valves of the valve modules, wherein the first work channel and the second work channel are connected so as to communicate via a connecting channel, and the valve module is assigned a valve means which can be switched individually by the control device between a shut-off position and an open position to have an influence on a free cross-section of the connecting channel, in order to temporarily open the communicating connection between the first and the second work channels.

2. A fluidic system according to claim 1, wherein the connecting channel is formed in a channel unit which has two fluid channels, designed to produce a communicating connection to the work channels, and which is designed to attach to a connection area of the valve module.

3. A fluidic system according to claim 1, wherein the valve means is designed as a 2/2-way valve.

4. A fluidic system according to claim 1, wherein the control device for intermittently activating the 2/2-way valves of the valve modules and the valve means is designed in the style of proportional servo valves, by applying a pulse-width modulation method.

5. A fluidic system according to claim 1, wherein a detection device, is arranged on and/or in the connecting channel, to determine an electrical measurement signal as a function of the fluid flowing in the connecting channel, the detection device being electrically coupled to the control device.

6. A fluidic system according to claim 1, wherein the control device is set up to activate the 2/2-way valves and the valve means in such a way that a temporary opening of the communicating connection between the first and the second work channels can be specified as a function of an operating state of a fluidic component coupled to the fluid channel and/or as a function of an electrical measurement signal of a detection device.

7. A fluidic system according to claim 1, wherein a first drive chamber of a fluidic drive device, is connected in communicating fashion to the first work channel and a second drive chamber of the fluidic drive device is connected in communicating fashion to the second work channel, and in that the drive chambers are separated from one another by a linearly movable drive element.

8. A fluidic system according to claim 7, wherein the control device is set up to activate the 2/2-way valves and the valve means in such a way that aerating or de-aerating the first drive chamber can be specified independently of de-aerating or aerating the second drive chamber.

9. A fluidic system according to claim 7, wherein the control device is set up to activate the 2/2-way valves and the valve means in such a way that when the drive element approaches an end position, determined by minimal volume in the respective drive chamber, an at least partial pressure equalisation between the drive chambers can be specified, so that the kinetic energy of the drive element can at least partially be converted into fluid pressure of a working fluid.

10. A fluidic system according to claim 7, wherein the control device is set up to activate the 2/2-way valves and the valve means in such a way that a pressure difference between the first and the second drive chambers of the fluidic work device can be specified to be constant in the course of a movement of the drive element.

11. A fluidic system according to claim 7, wherein the control device is set up to activate the 2/2-way valves and the valve means in such a way that in the course of a movement of the drive element, a pressure equalisation can be specified between the drive chamber of the fluidic work device made smaller by the movement of the drive element and the drive chamber of the fluidic work device enlarged by the movement of the drive element.

12. A fluidic system according to claim 1, wherein the 2/2-way valves are designed as valve units, in which the actuation means forms a compact unit with a valve section, this compact unit being attached to the mounting area of the channel body or channel unit, wherein the valve section comprises the first and the second fluid connections and a valve seat, with respect to which the valve member is arranged free to move, in order to have an influence on the free fluid channel cross-section between the first and the second fluid connections between a shut-off position and an open position.
